(19) United States
(12) Patent Application Publication
(10) Pub. No.: US 2014/0195931 A1
(43) Pub. Date: Jul. 10, 2014

(54) Validated Product Recommendation System And Methods

(71) Applicant: dotbox, inc., (US)

(72) Inventors: Thomas C. Kwon, Paramus, NJ (US); Paul Tan, New York, NY (US); David Porzio, New York, NY (US)

(21) Appl. No.: 13/831,203

(22) Filed: Mar. 14, 2013

Related U.S. Application Data
(60) Provisional application No. 61/749,852, filed on Jan. 7, 2013.

(51) Int. Cl. H04L 29/06

(52) U.S. Cl. CPC H04L 65/403
USPC 715/753

(57) ABSTRACT

Methods and systems for generating, in real-time, validated product recommendations by a community of like-minded users. In one embodiment, the community of like-minded users is generated based on browsing history, scoring of interactions, and social graph. Users may sign on to an interactive toolbar implemented within a website to interact with each other via the interactive toolbar, and obtain, in real-time, validated product recommendations from other users and experts.

### CROSS-REFERENCE TO RELATED APPLICATION(S)

The present application claims priority to and benefit from U.S. Provisional Patent Application No. 61/749,852 titled “Real-Time Validated Product Recommendation Apparatus, Methods and System,” filed on Jan. 7, 2013, the content of which is incorporated by reference herein.

### BACKGROUND

Consumers who are looking for recommendations generally seek advice from their family or friends in-person or via email or phone. Some consumers read articles and expert reviews on online websites, buyer reviews on merchant websites (e.g., product reviews by buyers on Amazon.com), consumer reviews on online directory service providers such as yelp.com. Since the product or service reviews available online can be generated by anyone, whether they have actually purchased the product or service or not, the truth or accuracy of such reviews are doubtful. Furthermore, many of the product or service reviews available online are old and out of date, and can be misleading.

### BRIEF DESCRIPTION OF THE DRAWINGS

FIG. 1 is a diagram of a representative environment in which the validated product or service recommendation system may operate.

FIG. 2 is a diagram illustrating an example application flow in the validated product or service recommendation system.

FIG. 3A is a block diagram of example components of the validated product or service recommendation system.

FIG. 3B is an example database diagram of the validated product or service recommendation system.

FIG. 4A is a logic flow diagram illustrating an example method implemented by the validated product or service recommendation system to check in and monitor user interaction and/or behavior.

FIG. 4B is a logic flow diagram illustrating an example method implemented by the validated product or service recommendation system to monitor user interaction and/or behavior.

FIG. 5 is a logic flow diagram illustrating an example method implemented by the validated product or service recommendation system for selecting user profiles for display in an interactive bar.

FIGS. 6A-D, 7A-B and 8A-D are example user interface diagrams illustrating an interactive toolbar in integrated within a website.

FIG. 9 is an example user interface of an admin dashboard of the validated product or service recommendation system.

FIG. 10 is a diagram illustrating an exemplary systemization of the validated product or service recommendation server.

### DETAILED DESCRIPTION

The validated product or service recommendation system and methods (hereinafter “validated product recommendation system”) described herein provide social e-commerce tools to facilitate creation of a community of like-minded consumers on the fly. Websites implementing the validated product recommendation system can host a perpetual social gathering destination directly on the website to instantly create a community of like-minded consumers and allow engagement and exchange between the consumers in the community. In one embodiment, the validated product recommendation system provides a platform for real-time interaction between consumers on a website, and validates user generated reviews in real-time. By allowing real-time interaction between consumers and monitoring the real-time interaction, the validated product recommendation system can enhance the purchase experience of consumers on a website. For example, when negative sentiments are detected in conversation streams, the validated product recommendation system may remedy or rectify such negative sentiments by suggesting or having a customer service representative or product expert join the conversation and offer assistance. The actions taken to improve the consumer's shopping experience in the website allows for increase in the conversion path.

In one embodiment, the validated product recommendation system allows consumers to obtain reviews and/or recommendations in real time or near real time from members of a trusted community and/or by an expert. Such reviews and recommendations are thus validated user-generated or expert-generated reviews, and are more trust worthy and relevant than user generated reviews found elsewhere on other online websites.

In one embodiment, the validated product recommendation system allows consumers to share their shopping choices by clicking on a purchase button, with no other prompts necessary. By seeing what a friend or another user has purchased, shopping decisions may be made more efficiently and in confident manner. The content in referrals may direct consumers to the relevant product pages, increasing website traffic. In a further embodiment, the validated product recommendation system allows real time purchases, likes or favorites, interests, etc., to be pulled from a merchant website and displayed on a social networking system (e.g., Facebook). From there, users can either share the content, or click to be linked to the product page for purchasing. This would help with increasing referral traffic to the merchant website, and show popular products as they are being purchased.

In one implementation, the conversion path to being a purchaser may be improved by providing targeted offers to consumers. The targeting of the offers may be based in part on a consumer's open graph data, data relating to interaction with other users via the validated product recommendation system's interaction bar, behavioral data relating to browsing of pages of a website, and the like. In another implementation, the validated product recommendation system may host exclusive website deals, which may benefit the merchant by promoting community growth, aiding in retail sales, and creating awareness around e-commerce offerings. The users may be rewarded for interacting with the merchant by designating them as members of an “Exclusive group.”

Various implementations of the validated product recommendation system and methods will now be described. The following description provides specific details for a thorough understanding and an enabling description of these implementations. One skilled in the art will understand, however, that the invention may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention.

### Example Environment and Architecture

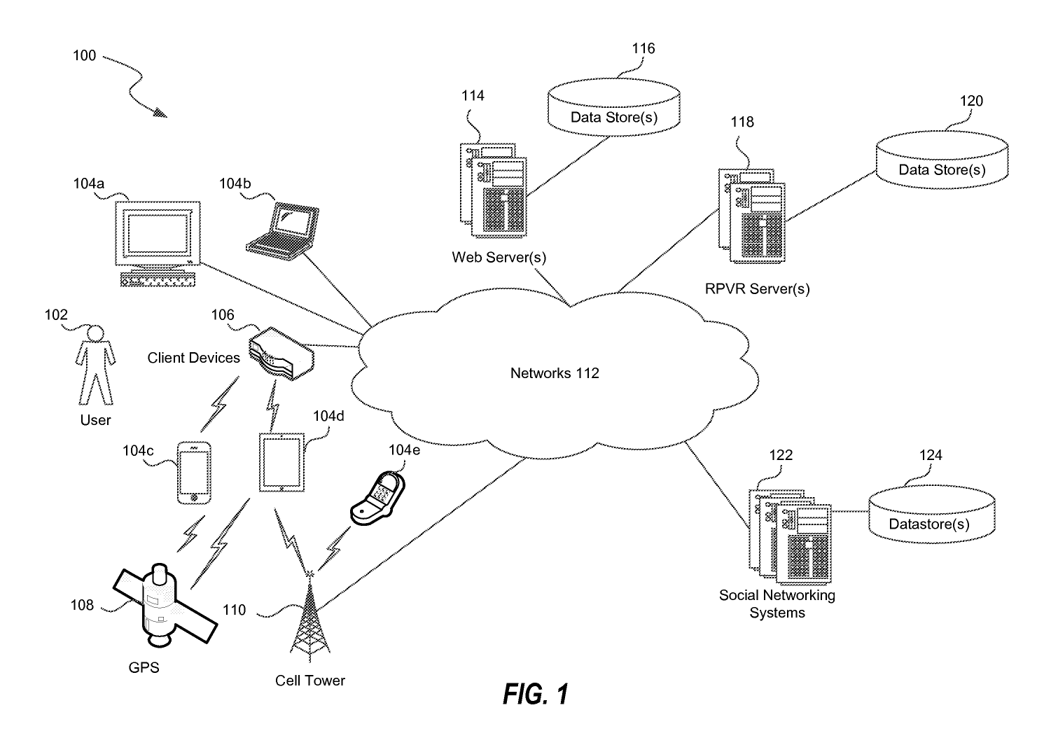

In one embodiment, the validated product recommendation system may be implemented in a suitable computing environment 100 shown in FIG. 1. Although not required, aspects and implementations of the validated product recommendation system will be described in the general context of computer executable instructions, such as routines executed by a general purpose computer, a personal computer, a server, or other computing systems.

The environment 100 may include one or more web servers 114 hosting websites that provide e-commerce or other products and services to consumers. The websites hosted on web servers may be accessed web or mobile browsers. Alternately, the web servers 114 may be accessed via desktop or mobile applications in one implementation. The environment 100 may also include one or more validated product recommendation servers 118 and a plurality of social networking systems 122. The web servers 114, the validated product recommendation server 118 and social networking systems 122 may connect to or communicate with each other across networks 112.

The environment 100 also include one or more users 102. A user 102 may utilize a website or application to access the services the web server 114, the validated product recommendation server 118 and/or the social networking systems 122 over networks 112 using a client device 120 such as, but not limited to, a computer 104a, a laptop 104b, a smart phone 104c, tablet 104d, a cellular phone 104e, and the like. One or more of the client devices 104 may include Global Positioning System (“GPS”) receivers to communicate with GPS satellites 108 to determine location. Networks 112 may include wired and wireless networks, private networks and public networks (e.g., the Internet). Client devices 104 may use their network interfaces to connect to and/or communicate with networks 112, either directly, or via wireless routers 106, or cell towers 110. Network interfaces may employ connection protocols such as direct connect, Ethernet, wireless connection such as IEEE 802.11a-n, and the like to connect to networks 112.

The validated product recommendation system provides and/or supports an interactive toolbar that is integrated with a website hosted on a web server 114. A user 102, using his or her client device 104, may access the website and check in to the interactive toolbar to, for example, interact with other users checked in to the interactive toolbar on the website. In one embodiment, the website may implement a piece of code or tag on its web templates. In a further embodiment, the piece of code or tag may include all the instructions necessary to generate the interactive toolbar and/or make application programming interface (API) or other method calls to the validated product recommendation server 118 to make queries and retrieve data (e.g., consumer profile data), process data, store data (e.g., interaction data), and the like. In one implementation, the interactive toolbar may be implemented using HTML and/or JavaScript. Ajax, jQuery, or other method calls may be used to get data for loading on the interactive toolbar.

In one embodiment, the retrieving, processing and storage of data may occur outside of the web services environment of the website, such that the interactive bar processes are not in the way of the web services, and there is no latency. In one embodiment, the validated product recommendation server 118 may be operated by or under the control of the operator of the website. In a further embodiment, the functions of the validated product recommendation server 118 may be performed by the web server 114. In an alternate embodiment, the validated product recommendation server 118 may be operated by a provider of the interactive bar. The interaction and other data captured from the interactive toolbar may be securely communicated to the validated product recommendation server 118 over networks 112. The validated product recommendation server 118 may be in communication with one or more data stores represented by data store 120. The web server 114 may be in communication with one or more data stores represented by data store 116.

The validated product recommendation server 118 may be in communication with the social networking system 122, which may include various online social networking systems such as Facebook, Google+, Twitter, Foursquare, and the like and/or social networking systems that users build by inviting other users to the interactive bar. The validated product recommendation server 118 may query the social networking system 122 and/or one or more data stores represented as data store 124 to obtain user information for creating a user profile, for example.

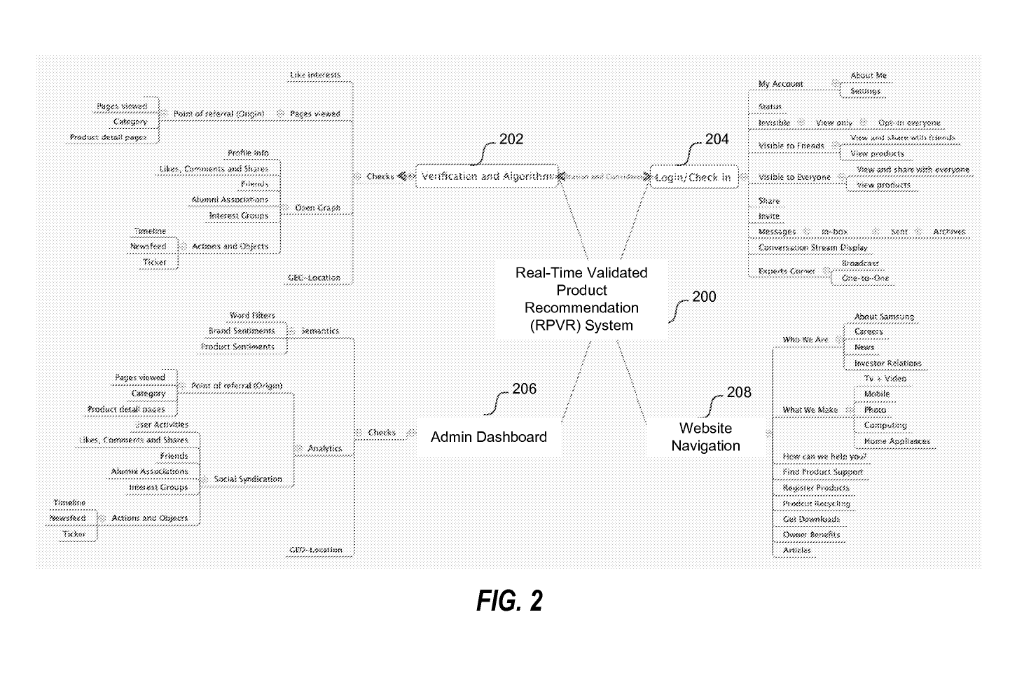

FIG. 2 is a diagram illustrating an example application or process flow in the validated product recommendation system 200. In one implementation, a website and an interaction bar integrated in the website may be loaded and rendered by a browser. In one embodiment, the login/check in component 204 may be executed. The login/check in may be implemented as a single sign on login using the Facebook Connect, or any other similar interface. Authentication may be handled by the provider of the single sign on service. For example, if Facebook Connect is implemented, a user is requested to provide a username and password for his or her Facebook account. The account provider authenticates the user and passes on a user ID and a token to the interactive toolbar and/or the validated product recommendation server. In one implementation, the login/check in component 204 may cause the interactive toolbar to be loaded with some basic information. The interactive toolbar may display various information, including user profile information, and options to configure one or more settings and/or update the user profile information.

For example, the interactive toolbar may display account information (e.g., information about the user, settings, etc.), status visibility options such as remain invisible, allow others to view only and/or opt-in everyone, be visible to friends, view and share with friends and/or view products, and the like. The interactive toolbar may also display options to share (products, pages, comments, statuses, etc.), invite other users, send messages, and the like. The interactive toolbar may also include a conversation stream display, an experts corner, with options to broadcast or have one on one conversation, and the like.

The website navigation component 208 may include various information and product pages of a website in which the interactive toolbar is implemented. A user may navigate the pages of the website over the network using a client device.

In one embodiment, the validated product recommendation system initiates verification and algorithm processes 202 which may obtain and/or aggregate user data from external sites such as the social networking systems (e.g., Facebook) for verification and processing. In one implementation, the validated product recommendation system may also track navigation or browsing behavior of a user on the website. For example, some information may be queried from and/or syndicated to external sites such as the Facebook via open graph API calls. Example information that can be aggregated from and/or syndicated to external sites such as the Facebook may include, but are not limited to: profile information, likes, comments, shares, friends, alumni associations, interest groups, actions and objects such as timeline, newsfeed, ticker, and the like. More or less information may be pulled from and/or syndicated to external sites depending upon user permissions or preferences in some implementations. In some implementations, geo-location information may also be obtained from the user's social networking and/or client device (e.g., mobile device location, cell tower, browser, IP address, GPS coordinates, and the like). The verification and algorithm processes 202 may also track and store website navigation information such as pages viewed, point of referral, category, product detail pages, date and time of viewing, and the like. The navigation history may be tracked using JavaScript/Ajax calls, for example.

In one embodiment, an admin dashboard component 206 displays a dashboard using which an admin (e.g., an operator of a website and/or a provider of an interactive toolbar) may select and analyze aggregated data and obtain a full view of all activities, past or present, associated with a website. Various types of interaction and/or behavioral data, metrics derived from such data, patterns, correlations, and the like may be provided on the admin dashboard in real time or near real-time. For example, the admin dashboard may include tools for querying users who are online, who are conversing, looking at a promotion, and the like as long as they are checked in. The admin dashboard may allow real time or near real time data mining, and can generate alerts when an event (e.g., a possible sale) occurs. The alert can then be directed to a sales person to close the sale. The admin dashboard may also include word filters to filter out words that may be deemed inappropriate. The admin dashboard may also include bots to detect or that can be trained to detect positive and negative words, contexts, and the like to gauge product sentiments, brand sentiments and the like. The dashboard may also provide a view (real time, near real time or historical) of pages viewed, category of pages of viewed, product detail pages viewed, social syndication and open graph activities, conversation stream views, and the like.

### Example Validated Product Recommendation System

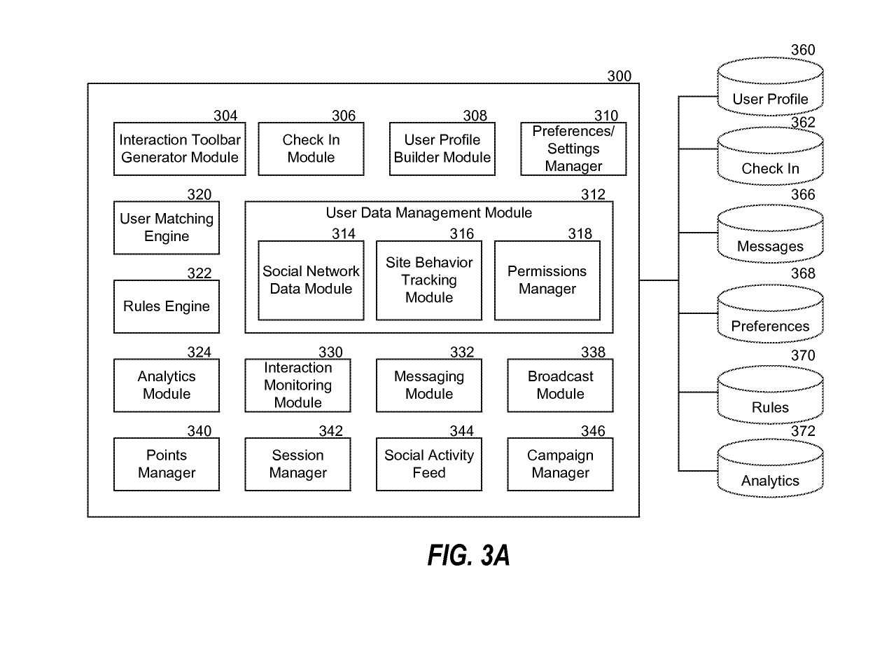

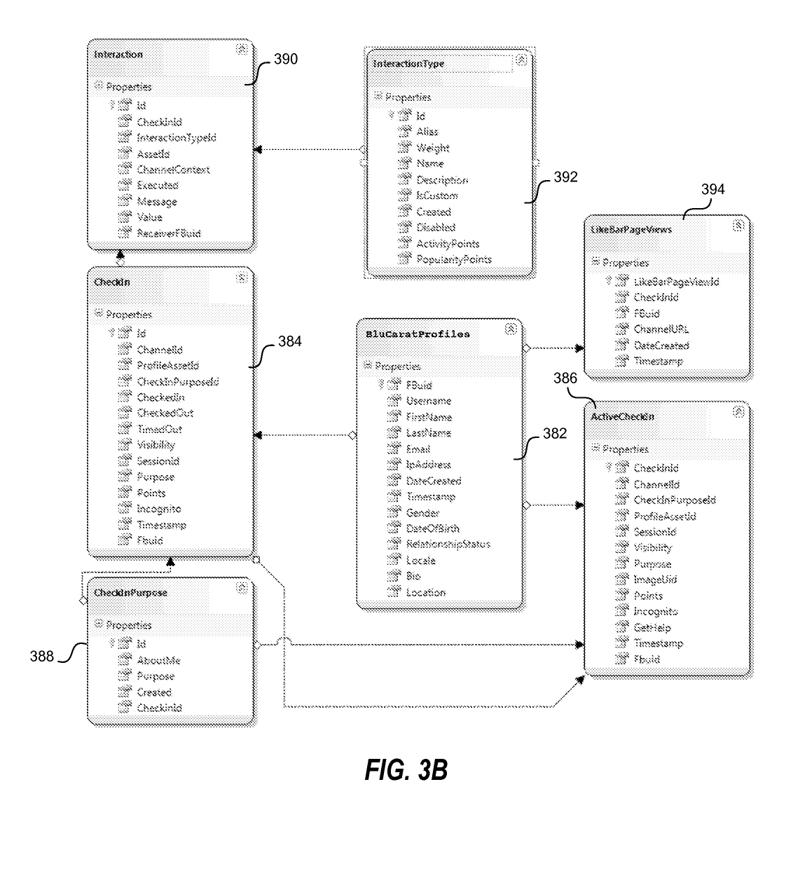

FIG. 3A is a block diagram of example components of the validated product recommendation system 300. In one embodiment validated product recommendation system 300 may include a plurality of modules or components that transform inputs such as like interests, pages viewed (i.e., website navigation or browsing behavior), open graph meta data (or meta data from other external sites), geo-location, and the like, to generate matching users, who have similar behavioral attributes, for interaction. The interaction, whether real time, near real time or delayed, may allow users of the interactive bar to receive and/or provide validated product/service recommendations from trusted sources and make informed decisions.

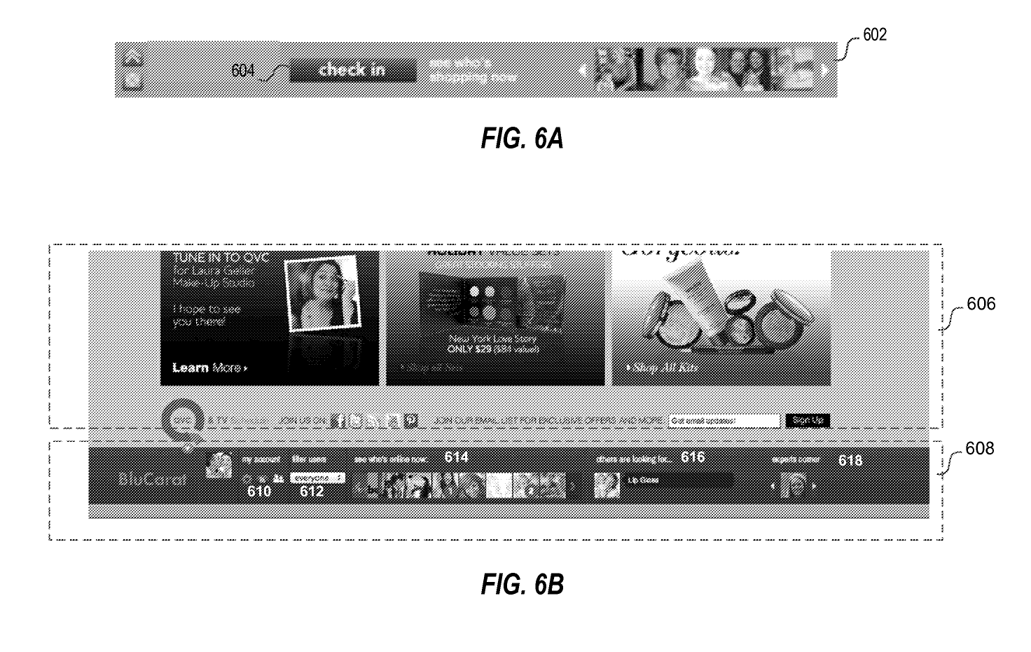

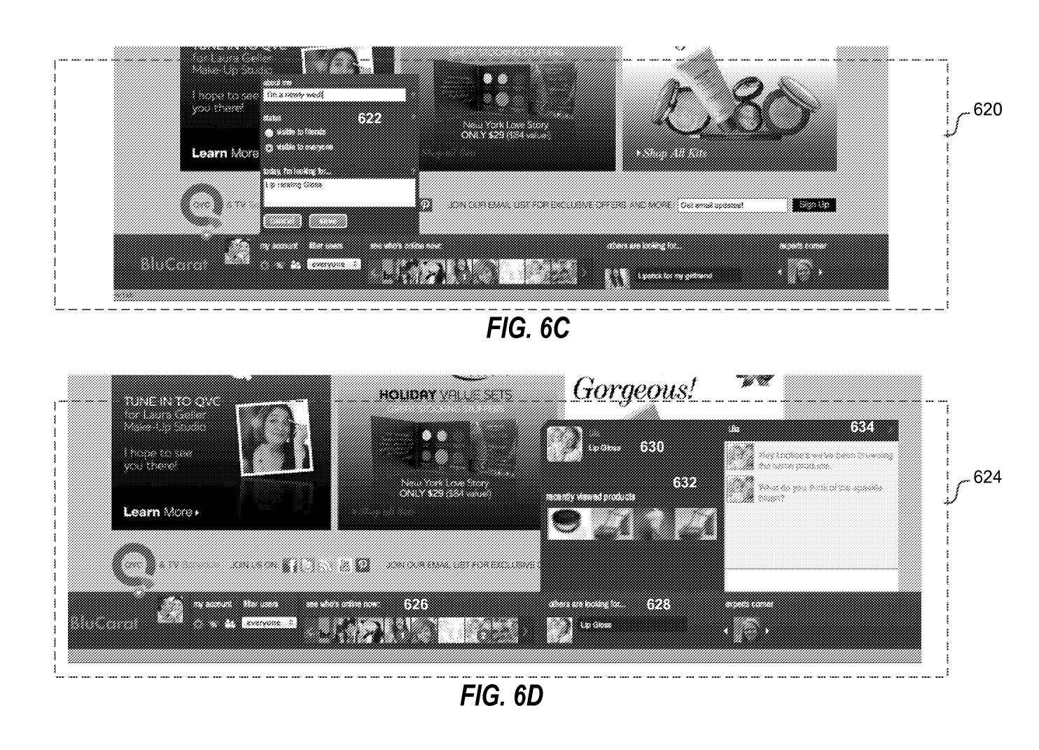

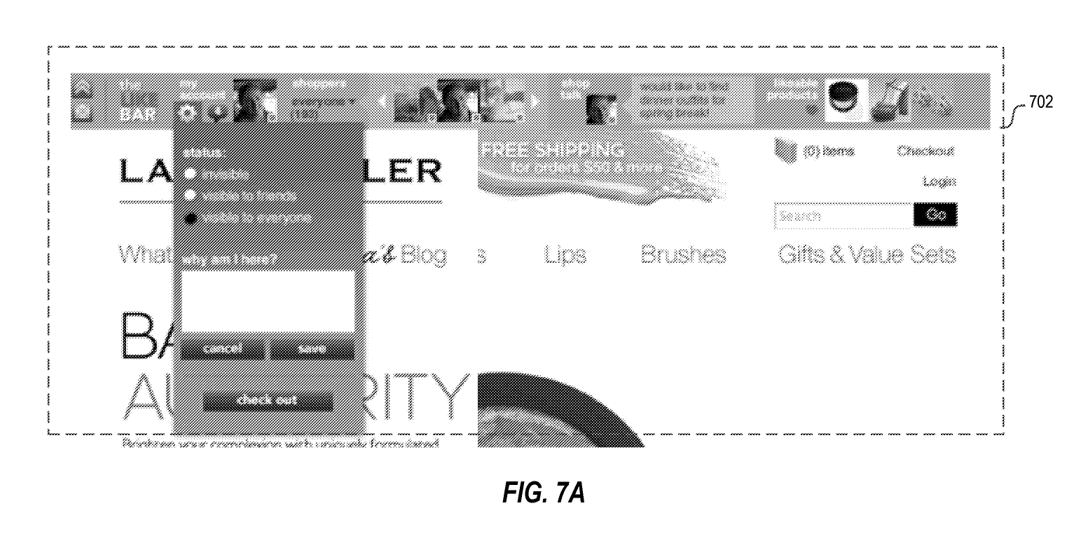

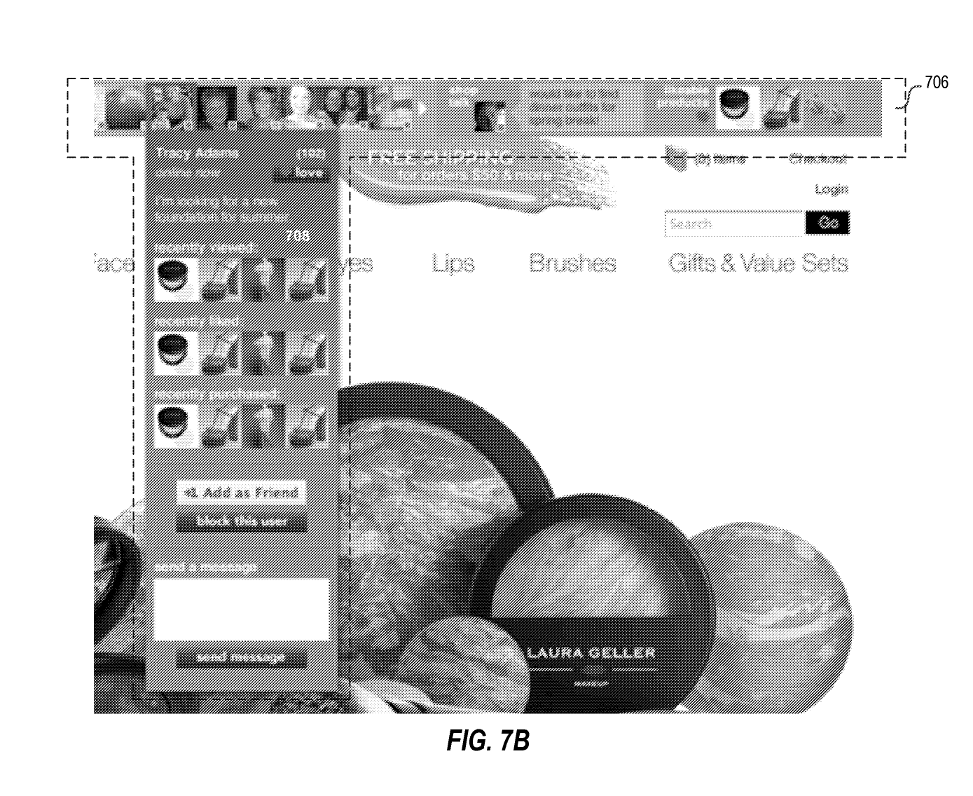

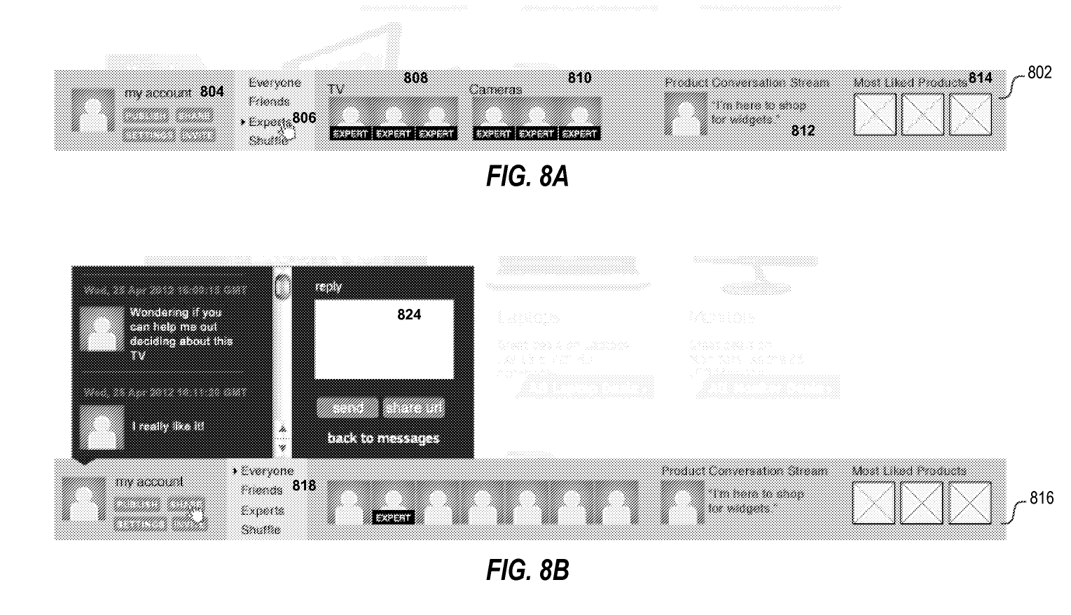

The validated product recommendation system 300, in one embodiment, may include a plurality of modules or components that implement various aspects. The validated product recommendation system 300 may include an interactive toolbar generator module 304, which includes HTML/JavaScript code snippet or tags that is executed to render an interactive toolbar at a desired location within a website. The module 304 may include options to customize the interactive toolbar using various skinning and cascading style sheets (“CSS”), for example. The interactive toolbar may be displayed at various locations within the frame of the website. For example, the interactive toolbar may be displayed at the top, bottom, sides, middle or any other location within a webpage displayed. In a further implementation, the interactive toolbar may be persistently displayed as the user navigates from one webpage to another on the same website. In one embodiment, the interactive toolbar may migrate with the user to another website supporting the interactive toolbar. For example, when a user, who is checked into an interactive bar of bestbuy.com, visits amazon.com, the interactive bar may migrate to amazon.com. In one implementation, the user's community members may change to reflect those users who are also browsing amazon.com. Alternately, the user may have an option to invite community members to join the interactive bar in amazon.com In a further embodiment, cookie or other session management method, may be implemented to make the migration appear seamless to the user. At the backend, certain information regarding the user, the community members, and other data may be exchanged between the websites, in one implementation. FIG. 6B depicts an example interactive toolbar 608 generated by the module 304 and rendered as part of a web page 606 by the browser.

In one embodiment, the validated recommendation system 300 may include a check in module 306 to log in/check in to the interactive toolbar. FIG. 6A depicts an example interactive toolbar 602 with a check in button that allows a user to check in and use the facilities provided by validated product recommendation system via the interactive toolbar. In one implementation, the check in module 306 may implement Facebook Connect or other similar interfaces. Facebook Connect includes a set of APIs that allow a user who is a Facebook member to log into the interactive toolbar using his or her Facebook identity or credentials. In addition to or alternate to Facebook Connect, a user may also use Twitter, other single sign on options that are similar or are functionally equivalent. In a further implementation, a user may check in using credentials specific to the validated product recommendation system and/or the website implementing the interactive toolbar.

When a user checks in to the interactive toolbar for the first time, a user profile builder module 308 may be triggered in one embodiment. The user profile builder module 308 may obtain or retrieve user profile data from external sites and/or the user to create a user profile record and store the user profile record in a database table such as the user profile database table 360. In one implementation, the user profile builder module 308 may obtain profile information permitted for sharing by the user from the user's Facebook, Twitter, Google, or other accounts. For example, the user profile builder module 308 may use Facebook Query Language (FQL), which has an interface similar to Structured Query Language (SQL), to query the data exposed by Graph API. Alternately, the user profile builder module 308 may request the user to provide at least some of the profile information. In one implementation, the user profile database table 360 may include various data fields such as, but not limited to: Facebook or other user ID, username, first name, last name, email, Internet Protocol (IP) address, date of user profile creation, time stamp, gender, data of birth, relationship status, locale, bio, location, and/or the like.

In one implementation, the check in module 306 may create a check in record for each instance of check in by a user and associate the check in record with a corresponding user profile record. The check in record may be stored in a database table, such as the check in database table 362. In one implementation, the check in database table 362 may include various data fields such as, but not limited to: check in ID, channel ID, profile asset ID, check in purpose ID, checked in, checked out, timed out, visibility, session ID, purpose, points, incognito, timestamp, Facebook or other user ID, and/or the like.

One embodiment of the validated product recommendation system 300 may include a preferences/settings manager 310 in one embodiment to obtain and/or manage preferences/settings and associate the preferences/settings with a user profile. Example preferences/settings may include status setting (invisible, visible to friends, visible to everyone), privacy mode (e.g., incognito mode), and the like. In one implementation, the preferences/settings may be stored in one or more database tables such as the preferences table 368. The preferences table 368 may include data fields such as, but not limited to: user ID, visibility status (e.g., friends only, everyone), incognito, and the like.

One embodiment of the validated product recommendation system 300 may include a social networking system data module 314 that connects to social networking systems such as Facebook, Twitter, etc., to obtain user information. The user information may be used to build a user profile (e.g., by user profile builder module 308) and/or for use by other modules of the validated product recommendation system 300. In one implementation, some basic user information (e.g., name, first name, last name, user name, gender, locale, etc.) may be available for public access, while additional user information may require user permission. The permissions manager 318 may obtain the necessary permission and store the permissions in association with the user profile. The social networking system data module 314 may use appropriate API calls, SQL query or other methods to obtain data. For example, the social network data module 314 may use the Graph APIs provided by the Facebook platform to get data from Facebook and provide the data for loading on the interactive toolbar and/or storage on a data store of the validated product recommendation server 118. The social networking system data module 314, in one implementation, may also handle exporting or syndication of data from the interactive toolbar to external sites. For example, the Graph APIs may be used to post data from the interactive toolbar to news feed, ticker, timeline, etc. Similarly, Twitter's APIs may be used to send tweets directly from the interactive toolbar.

One embodiment of the validated product recommendation system 300 may include a site behavior tracking module 316 to track browsing history or behavior of a user, who is checked in to an interaction bar, on a website. For example, the site behavior tracking module 316 may track page views, category of page views (e.g., home/index, new arrivals, Women, Men, Kids, Jewelry, Bags, Shoes, Wedding, Sale, etc. of xyzretail.com), product detail pages viewed (e.g., product ID 85197, Merino Cardigan, etc.), point of referral or origin, page/product view duration, click path or bread crumb trail, click, and/or the like. The site behavior tracking module 316 may use, for example, page tagging (JavaScript based), server logging and/or any other methods to detect and identify page views, product detail page views, and the like.

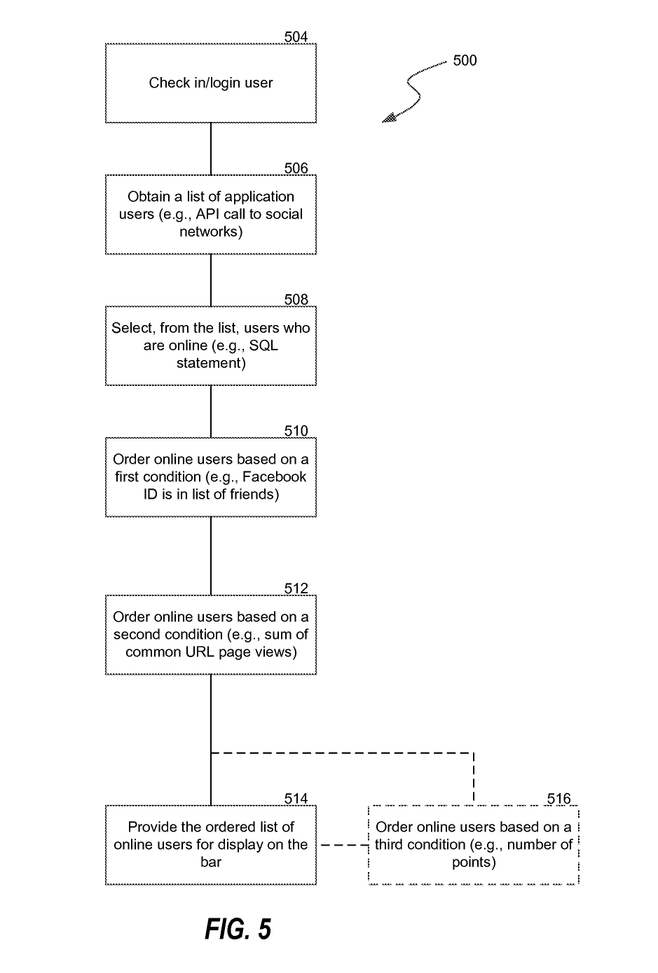

One embodiment of the validated product recommendation system 300 may include a user matching engine 320. In one implementation, the user matching engine 320 may facilitate instant community building and crowd sourcing by bringing together users with similar interests, behavior, demographics, networks, and other attributes. In one implementation, the user matching engine 320 may identify and/or select, based on one or more criteria, a list of matching users who are best suited for interaction with the user. The user matching engine 320 may further sort or order users according to one or more criteria to obtain an ordered list of users matched for interaction with the user. The user matching engine 320 may implement the method 500 illustrated in FIG. 5 in one embodiment to identify a suitable list of users for interaction with the user. The interactions may be in real-time, near real-time or delayed. The interactions may include passive interactions where one user views recently viewed products, purchases, shares, check in purpose, and the like shared by another user. Some interactions may be active interactions, where one user may send instant messages to another user. The active interactions may be supported by a messaging module 324. In one implementation, the user matching engine 300 may identify and select matching users for a user, each time the user checks in. Such an implementation may allow the user matching engine 320 to take into consideration the user's check in purpose, changes in social circles, availability of users who are online, and the like. In another implementation, the user matching engine 300 may have a core list of matching users (e.g., users who are explicitly “friended” or invited by a user, users with whom a user interacts frequently, etc.) that does not change, and other matching users who may change depending on circumstances. In yet another implementation, the matching users may be refreshed dynamically, periodically or continually (e.g., when a new user checks in).

One embodiment of the validated product recommendation system 300 may include a messaging module 324 that may provide a messaging platform to allow users to send messages to each other. In one implementation, the messaging module 324 may deliver a message to one or more intended recipients in real-time or near real-time if the intended recipients are online. Alternately, if an intended recipient is offline, the messaging module 324 may store and forward the message the next time the intended recipient checks in. In one implementation, the messages may be forwarded to an offline user via email, SMS, MMS, via social network syndication, and the like. In one implementation, the messages for store and forward may be stored in a database table such as the message table 366. The message table may include various data fields such as, but not limited to: sender ID (e.g., Facebook ID or other user ID), recipient ID, message subject, message body, date/time stamp, and the like.

One embodiment of the validated product recommendation system 300 may include an interaction monitoring module 326 that may monitor interaction between users as they occur. The interaction monitoring module 326 may parse and analyze the semantics of the conversation stream. For example, the interaction monitoring module may use word filters to detect use of certain words in a conversation stream, which can provide insight into the conversation. The semantics module may also use semantics to gauge brand sentiments and product sentiments. In a further implementation, the interaction monitoring module 326 may generate a meaningful summary of any conversation stream and recommend and/or undertake certain actions to lead the users down a conversion path (e.g., a window shopper to a paying customer). The results of the semantic analysis may be provided to the analytics module 328 for further analysis and/or data presentation/reporting.

One embodiment of the validated product recommendation system 300 may include an analytics module 328 that may provide an admin dashboard or similar user interface and/or tools for tracking, visualizing, and reporting raw and/or processed analytics data. Example analytics data may include page views, logins/check ins, top page check ins, product page views, demographics, new users, and the like. The analytics module 328 may aggregate and/or mine rich social graph data for conversation marketing and community building. The analytics module 328 may also capture user interaction data. The analytics module may aggregate, analyze and/or correlate analytics data, such as conversation stream, page views, and the like, to determine key influencers of negative (e.g., no sale) and positive conversation (e.g., close the sale). Custom metrics such as top influencers, top status, sentiments, and the like may be defined in the analytics module by an admin (e.g., operator of the website, provider of the interactive toolbar). In one implementation, the analytics data aggregated and/or generated by the analytics module 328 may be stored in one or more database tables such as the analytics table 372. The analytics table may include various data fields such as, but not limited to: number of check ins, number of new users, number of shares, demographics, most visited pages/URLs, top influencers, top statuses, sentiments, date, other metrics, and the like.

In one implementation, the validated product recommendation system 300 may implement a rules engine 322. The rules engine 322 may include instructions and/or data defining one or more rules for an interactive toolbar and/or website. For example, in one implementation, the rules engine 322 may include a rule that triggers an expert or sales person to join a conversation on the interactive toolbar whenever the interaction monitoring module 326 detects a negative brand or product sentiment from the conversation. By way of another example, the rules engine 322 may include a rule that automatically generates and/or provides an offer to a user who is the top influencer of the day, week, month, etc. By way of yet another example, the rules engine 322 may include a rule that detects when a particular product item, any item from a particular brand, etc., has been viewed by a threshold number of users and triggers an instant sale of the particular product item or any item from the particular brand. In one implementation, one or more rules may be defined or modified on the fly by an admin for immediate execution by the rules engine 322 to instantly effect behavioral changes in users who are checked in to the interactive bar. In one implementation, the rules that are evaluated by the rules engine 322 may be stored in one or more database tables such as the rules table 370. The rules table 370 may include various data fields such as, but not limited to: rule ID, expression, outcome, action, priority, and the like.

One embodiment of the validated product recommendation system may also include a broadcast module 338 that may provide a website operator broadcast capabilities to, for example, announce sales, offers, availability of experts, and the like in real-time via an interaction bar integrated with the website. In one implementation, the broadcast module 338 may be leveraged by the rules engine 322 to announce decisions such as a sale, an offer, etc. In the event of decisions affecting a single user, the messaging module 324 may be leveraged by the rules engine 322 to inform the single user of the decision. In another implementation, the broadcast module 338 may also be used by an admin to announce sales, offers, availability of experts, etc. In one implementation, user interfaces for the broadcast module 338 and/or messaging module 324 may be present in an admin dashboard.

The validated product recommendation system 300, in one embodiment, may include a social activity feed 340 to display, in real-time, user activities on a website on an interactive toolbar of the website. For example, the social activity feed may include information relating to items other users are looking for and/or have been recently viewed, trending products, products that are running out of stock, flash sales, example product conversation streams or messages, and the like.

In one embodiment, the validated product recommendation system 300 may include a campaign manager 342 to create and manage campaign events. In one implementation, the campaign manager 342 may leverage the integration with social channels to make campaign events viral. For example, flash sales, special guests, offers, deals, experts, etc., can be announced to consumers in real time, and consumers in turn can post such campaign details on their social networking system pages. New e-commerce offerings can be promoted on social media, driven by an engaged community.

One embodiment of the validated product recommendation system 300 may include a session manager 344 to allow a website's visitors to invite other users or friends to help make shopping decisions and foster conversation. Any friends, including those who have not checked in to an interactive toolbar on the website, or are not users of the interactive toolbar may be invited. In one implementation, a user may organize or plan a shopping session at a desired date/time, invite friends or other users and have an expert (e.g., a stylist, a sales representative, a customer representative, etc.) available during that time to provide information, recommendation, expert reviews, and the like.

One embodiment of the validated product recommendation system 300 may include a points manager 346 that may assign points to and/or keep track of points obtained by users of the validated product recommendation system. In one implementation, the points manager 340 may assign points (e.g., activity points, popularity points) for performing certain activities, achieving certain popularity status, and/or the like. Example activities that may earn points (e.g., activity points) may include sending messages, a minimum number of check ins during a time period (e.g., check in once a week to get a point), declaring check in purpose, and the like. Activity points may also be awarded to the user based on number of page views, for example. Popularity points may be awarded to user for influencing threshold number of users (e.g., 1 popularity point for 10 users, 5 popularity points for influencing 20 users, and so on), for being a top x influencer (e.g., top 10 influencer), for posting a top status, and the like. In one implementation, activity points and popularity points may be the same, while in another implementation, they may be weighted differently.

One embodiment of the validated product recommendation system 300 may also include an accounting module (not shown). The accounting module may be configured to keep track of the use of the interactive bar and generate a usage based fee payable to a provider of the interactive bar. For example, in one embodiment, the fee model may correlate number of check ins (unique check ins or aggregate check ins) in per period of time to determine a fee amount. In a one implementation, usage may be quantified in various other ways (e.g., per click, total user base, etc.). Alternately, a license based fee model may be implemented.

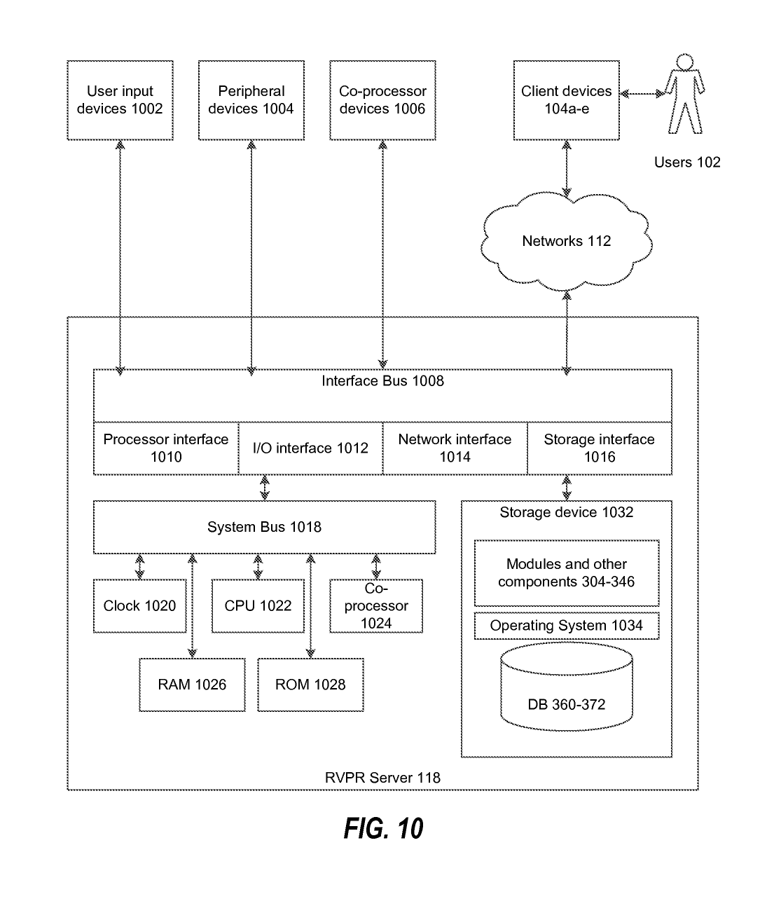

It should be noted that the validated product recommendation system 300 may include more or less components/modules/engines and database tables. As used herein, a “module,” a “manager” or an “engine” includes a general purpose, dedicated or shared processor and, typically, firmware or software modules that are executed by the processor. Depending upon implementation-specific or other considerations, the module, manager, handler, or engine can be centralized or its functionality distributed. For example, one or more modules may reside on the web server 114 or another server (e.g., a host server) associated with a website, while some modules may reside on the validated product recommendation server 118 that may be controlled by a provider of the interactive toolbar. The module, manager, or engine can include general or special purpose hardware, firmware, or software embodied in a computer-readable (storage) medium for execution by a processor, described in detail with respect to FIG. 10.

FIG. 3B is an example database diagram of the validated product recommendation system. When a user who does not have a profile, signs in to the interactive toolbar on a website, the validated product recommendation system creates a profile for the user. The profile creation process pulls information available from the external site such as Facebook to build a user profile and saves the user profile in table 382. The validated product recommendation system then creates a check in record 384 and then equates the check in to active check in table 386. The user can then declare a check in purpose which is stored in table 388. After the user is checked in, all user interactions, such as messages exchanged with others, are saved in table 390 under various interaction types listed in table 392. As the user navigates through the website, the page views and details are saved in table 394. The data fields associated with each of the tables 382-394 are exemplary and non-limiting, and may include more or less data fields in other implementations.

### Example Processing

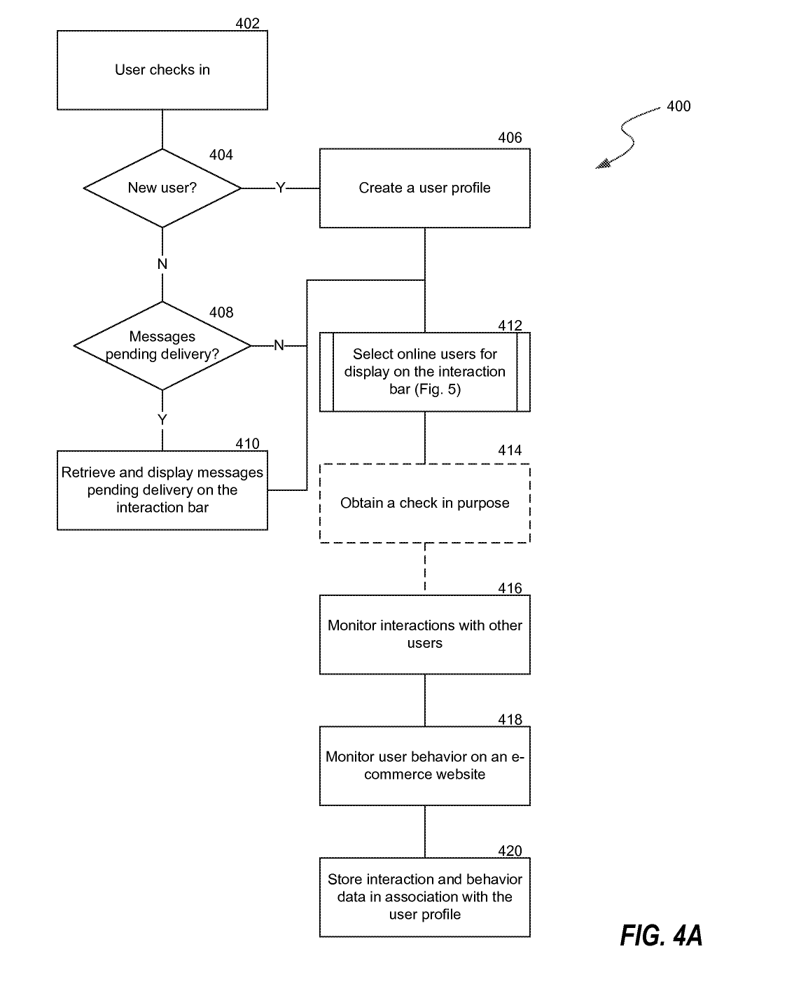

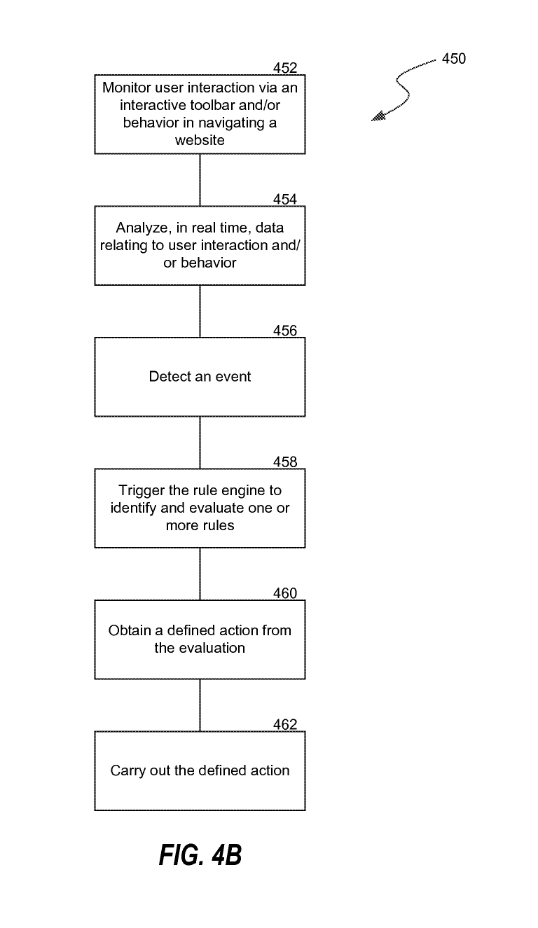

FIG. 4A is a logic flow diagram illustrating an example method 400 implemented by the validated product recommendation system to check in and monitor user interaction and/or behavior on a website having an integrated interactive toolbar. In one embodiment, a user may access a website implementing an interactive toolbar. At block 402, the user may check in to the interactive toolbar by providing a single sign on username and password associated with an external site such as Facebook, Twitter, Google, etc., that authenticates the user. The external site may authenticate the user and pass on the user ID and an auth token to the validated product recommendation system, using which the validated product recommendation system may request data from or send data to the external site. Alternately, login credentials for the website or the interactive toolbar may be used to authenticate the user. The authentication may be performed by the web server, the validated product recommendation server or an authentication server on behalf of the web server or the validated product recommendation server.

At decision block 404, the validated product recommendation system may determine whether the user is checking in for the first time, and is thus a new user. In one implementation, the validated product recommendation system may query the user profile table 360, for example, to determine if a user profile record for the user ID (e.g., the user ID provided by the external site or created by the user for the website or the interactive toolbar) already exists. If the user is a new user, the validated product recommendation system creates a user profile record for the user at block 406. The validated product recommendation system may obtain information for the user profile by making API calls to the external site, and/or requesting information from the user. If the user is not a new user, the validated product recommendation system may determine if there are any messages pending delivery to the user at decision block 408. The validated product recommendation system may allow users to send messages to other users even if they are not checked in at the same time. The messages that are received by the user while he or she is not checked in are stored and delivered when the user checks in. If there are any messages pending delivery, the validated product recommendation system may retrieve the message (e.g., from message table 366), and provide the messages to the user via the interactive toolbar at block 410. Alternately, the validated product recommendation system may send a notification to the user regarding unread messages and provide the unread messages to the user when requested.

After creating a new user profile at block 406, or after delivering the unread messages at block 410 or when there are no unread messages to deliver at decision block 408, the process may move to block 412. At block 412, the validated product recommendation system may identify and select a list of online users based on one or more criteria for display on the interactive toolbar. Block 412 is described in detail with respect to FIG. 5.

In one implementation, the validated product recommendation system may obtain from the user, a check in purpose and/or other visibility status changes at block 414. In one implementation, such information may be changed by the user, at any time, while the user is checked in to the interactive toolbar. In a further implementation, any changes to the settings may persist between sessions with the interactive toolbar. For example, if the user changes his or her status to “visible to everyone,” the status may remain the same when the user checks in to the interactive toolbar the next time.

At block 416, the validated product recommendation system monitors interactions between the user and other users via the interactive toolbar. For example, the validated product recommendation system may monitor the messages sent and/or received by the user, products recommended by the user, shares, invites, and the like. In one implementation, any interaction with or via the interactive toolbar may be monitored. At block 418, the validated product recommendation system monitors user behavior on the website. User behavior that may be monitored include, for example, Uniform Resource Locator (URL) page views, category page views, click through, product page/item views, favorites, add to carts, and the like. At block 420, the user interaction data and behavior data associated with a user may be stored in association with his or her user profile (e.g., user ID) in a database table (e.g., analytics table 372).

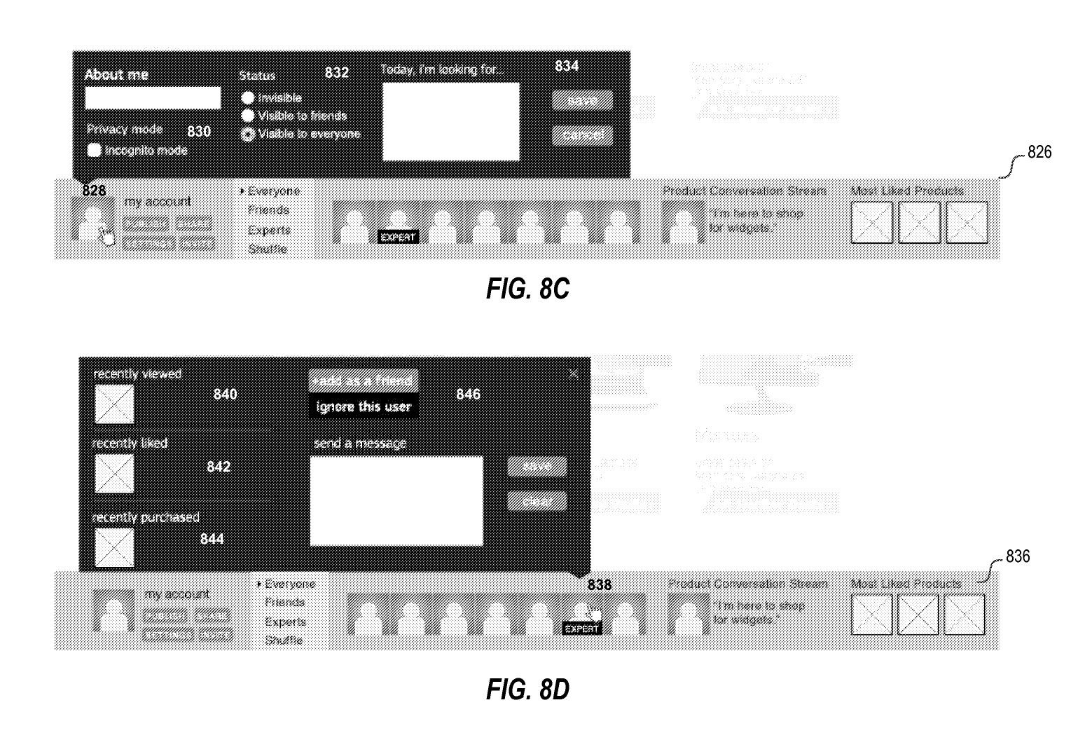

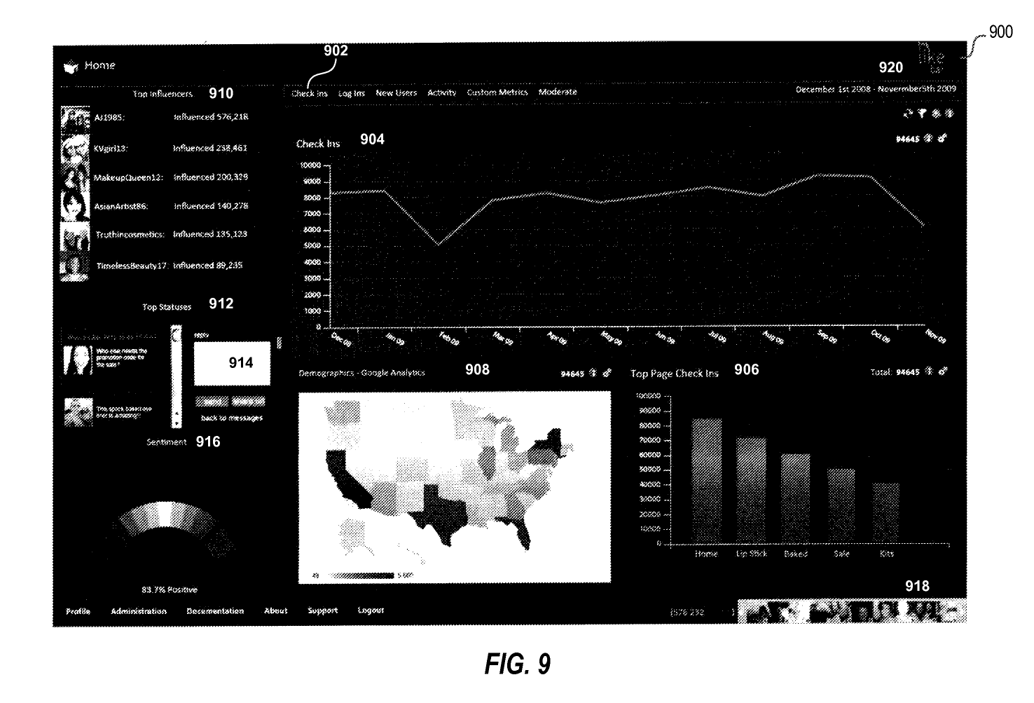

FIG. 4B is a logic flow diagram illustrating an example method 450 implemented by the validated product recommendation system to monitor user interaction and/or behavior. In one implementation, at block 452, user interaction with or via an interactive toolbar and/or user behavior such as browsing behavior on a website implementing the interactive toolbar is monitored. At block 454, the user interaction and/or behavior data from the monitoring may be analyzed in real time (e.g., by the analytics module 324). The analysis may be used to determine certain metrics, patterns, statistics, and the like. Example results of analysis are described in detail with respect to FIG. 9. In one implementation, analysis may be in near real-time or not in real time, and may be subject to configuration by the admin or operator of the website and/or the provider of the interactive toolbar.

At block 456, an event may be detected based on monitoring of the user interactions and/or behavior, or alternately from the results of the analysis at block 454. An example event may include use of positive or negative sentiments with respect to products, brands, and the like, use of certain brand names or product names, achievement of activity points, popularity points or aggregate points, influencing a user, recommending a product, sending a message, responding to a message, and the like. For example, when a user exchanges messages with another user, the messages may be monitored. In one implementation, the messages may be passed on to the interaction monitoring module 326, which can parse and analyze the messages and detect use of positive, negative or other desired words, terms, phrases, etc.

At block 458, the detected event may trigger the rules engine 322, which may identify and evaluate one or more rules (e.g., rules stored in the rules table 370) to determine a defined action to be taken as a result of the detected event. For example, when a negative sentiment is detected from monitoring of the conversation stream, the event may trigger the rule engine to identify a rule associated with negative sentiments, and evaluate the rule. For example, the identified rule may specify that a notification be sent to an expert when at least two instances of negative sentiments against the same brand have been detected during a time period. At block 460, the results from the evaluation may be obtained. The results may include one or more defined action to be taken. For example, if an outcome of the evaluation of the rule is true (e.g., at least two instances of negative sentiments against the same brand have been detected), a defined action would be to send a notification to the expert to rectify the situation. At decision block 462, the defined action is carried out by the validated product recommendation system. For example, the validated product recommendation system may generate a message alerting the expert concerning the negative brand sentiment, the associated users, suggested course of action, and the like.

FIG. 5 is an example method for matching users for display in an interactive toolbar of a website. In one implementation at block 504, a user checks in to the interactive toolbar using any of the methods described above. At block 506, the validated product recommendation system queries an external site such as a social networking system (e.g., Facebook) to get a list of users who have checked in to the interactive toolbar before. The query may be in the form of an API call to Facebook, for example. Alternately, the query may be to a database table that includes a list of users who may or may not be members of social networking systems. In one implementation, the list of users may or may not have a social relationship (e.g., friend, friend of a friend, etc.) with the user. At block 508, from the list of users, only those users who are online or checked in may be selected. The selecting may be based on a SQL statement (e.g., the SELECT statement where online is true) for example. At block 510, the list of online users may be ordered based on a first condition. For example, the list of checked in users may be ordered based on the condition that users with Facebook IDs (FBuid) who are in the list of friends of the user are given higher priority over others. The profile of the higher priority users may then be displayed before or featured over other users. In one implementation, if the number of users is higher than a threshold, only a top x number of users may be selected for further ordering.

At block 512, the list may be ordered further based on a second condition. For example, the list may now be ordered based on the sum of common page (or URL) views. In other words, users on the list who viewed the same pages as the user are prioritized over other users. The URL views may consider product views, sub-category views, category views, and the like. In one implementation, if the number of users in the list after the ordering is higher than a threshold, only a top y number of users may be selected from the list.

In some implementations, the users on the list may be ordered further based on a third condition and so on. For example, at block 516, the users may be ordered based on the number of points. In one implementation, points or weights may be given to users for the same page viewed, the number of times the same URLs were viewed, and the like. In another implementation, each user on the validated product recommendation system may be given points (e.g., activity points, popularity points) based on interactions and activities on the validated product recommendation system. Those users with more points may be placed before users with fewer points. In one implementation, if the number of users after the ordering is higher than a threshold, only a top z number of users may be selected from the list. It should be noted that x, y and z may be any number, and may not necessarily be equal. The final list of matching users may then be provided for display on the interactive toolbar illustrated in FIGS. 6-8.

### Example User Interfaces

FIGS. 6A-D are example user interface diagrams illustrating an interactive toolbar integrated within a website such as an e-commerce website. Referring to FIG. 6A, the interactive toolbar 602 displays the initial user interface for checking in to the validated product recommendation system. The interactive toolbar 602 includes a check in button 604, and in some implementations, images of users who are online or checked in to the interactive toolbar 602. As previously described, users may login/check in by using their social networking system (e.g., Facebook, Twitter, Google+, etc.) or other external system credentials, or by using login credentials specific to the interactive toolbar and/or the website. When login credentials associated with an external site are used, authentication is handled by the external site.

Although the interactive toolbar is depicted as a rectangular bar, it should be noted that the interactive toolbar may take on any desired shape (e.g., oval, circular, irregular, etc.), and may be customizable. The customizations may include customization of the look and feel of the interactive toolbar, and/or functional aspects.

Referring to FIG. 6B, an interactive toolbar 608 is positioned at the bottom of a webpage 606 of a website. The interactive toolbar 608 includes account management options 610 for managing a user account, signing in or out, configuring settings, publishing. sharing, inviting other users, and the like. The interactive toolbar 608 may also provide an option for the user to go into an invisible or incognito mode in one implementation.

The user can also set a filter 612 to select users for interaction. Some options may include, everyone, friends, shuffle, and the like. The everyone filter includes all users who are currently online and the friend filter includes only those users with whom the user has a relationship (e.g., a friend relationship, a friend of a friend relationship, family relationship, etc.). In one implementation, the friend filter may take into account relationships from the social networking systems or other external sites from where the user information is pulled and/or relationship initiated by the user within the environment of the interactive toolbar. The shuffle filter may select users randomly, or based on one or more criteria (e.g., similar demographic, similar page views, geographic location, etc.) defined by the validated product recommendation system. The interactive toolbar 608 displays a list of users 614. In one implementation, the list of users may include all users who are online, subject to filter condition. In another implementation, the list of users may include those users selected and ordered by the method described in detail in FIG. 5, and in one implementation, may also be subject to a filter condition, if specified.

In one implementation, users may declare a check in purpose to announce what they are looking for or interested in, for example. The interactive toolbar may display the check in purpose or other social/activity feed 616 from one or more users. The purpose may include a message concerning items that online users are looking for. In some implementations, an expert's corner 618 may be included to provide users access to the assistance or expertise of a sales, customer or other representative working for the website.

Referring to FIG. 6C, the interactive toolbar 620 displays an overlay 622 where a user can input information about himself or herself. For example, the user can write something about himself or herself, set a status (visible to friends or visible to everyone), declare an intention or a check in purpose (e.g., 616 in FIG. 6B) and the like.

Referring to FIG. 6D, the interactive toolbar 624 depicts an overlay 630 that is displayed when a user selects or hovers over an image/icon of another user (e.g., user 628). The overlay may display recent or all activities of the selected user. For example, products recently viewed 632 by the selected user “Lila” 628 is displayed. Users may also exchange messages with the selected user using the messaging box 634. In one implementation, if there are messages pending, an indicator may be displayed next to the image thumbnails of matching users or users who are online (e.g., 626), to notify the user of pending messages.

FIGS. 7A-B are example user interface diagrams illustrating an interactive toolbar integrated within a website. Referring to FIG. 7A, an interactive toolbar 702 is displayed at the top of a webpage of a website, and includes many of the elements described with respect to FIGS. 6A-D. Referring to FIG. 7B, an interactive toolbar 706 is displayed at the top of a webpage of a website. When a user selects or hovers over a thumbnail image of another user from the list of users depicted, an overlay 708 may be displayed. The overlay may include information about the selected user, such as the number of friends, online/offline status, an option to favorite the selected user, a check in purpose, a list of recently viewed items, a list of recently liked items, a list of recently purchased items, an option to add the selected user as a friend (if the user is not a friend), an option to block the selected user, an message box to input and send a message to the selected user, and the like.

FIGS. 8A-D are examples of alternate user interface diagrams illustrating an interactive toolbar. Referring to FIG. 8A, the interaction toolbar 802 depicts a user account area 804 that includes options to manage user account, publish information on the interactive toolbar or externally to social networking systems, share, change settings, invite users, and the like. The user may also set visibility options. For example, if the user selects the expert option 806, experts relating to various categories of products sold or serviced by the website (e.g. TV experts 808, cameras experts 810, etc.) may be displayed. The interactive toolbar also depicts product conversation stream 812, that may change dynamically, as other users come online and declare their purpose. In one implementation, the validated product recommendation system detects users having similar check in purpose to the user, and the like, and features user profiles associated with the detected users on the interactive toolbar. The interactive toolbar also depicts information that can provide an overview of the activities of the users of the interactive toolbar at any given time. For example, the most liked products section 814 displays products that are popular among the users of the interactive toolbar at a given time.

Referring to FIG. 8B, the interactive toolbar 816 depicts use of the share functionality to share URLs of desired or current web page and post a message using box 824. Referring to FIG. 8C, an interactive toolbar 826 is depicted. A user 828 can configure his or her status 832, intent or purpose 834, privacy mode 830, and the like on the interactive toolbar. Referring to FIG. 8D, an interactive toolbar 836 is depicted. As shown a user can select another user 838 and add the selected user as a friend 846, send a message, view the selected user's browsing and/or purchasing history (e.g., 840, 842, 844), and the like.

FIG. 9 is an example user interface of an admin dashboard 900 that may be accessed by an administrator or operator of the website, and/or the interactive toolbar provider. As depicted, the admin dashboard 900 includes charting, graphing and other visual tools for selecting, processing and visualizing interaction and behavioral data aggregated from the users of the interactive toolbar by the validated product recommendation system. In one implementation, an admin may specify a date range 920, and view various types of data corresponding to the specified date range. For example, when check in data 902 is selected, the check in data corresponding to the specific date range is retrieved and graphically displayed (e.g., by the analytics module) on a chart 904. The admin may also select other types of data that may be aggregated by the analytics module, for example. Other types of data may include and but are not limited to: number of log in (total or unique), number of new users, number of activities (total or by activity type), custom metrics (e.g., number of log ins from a geographical area, number of check ins looking for shoes, etc.). These and other data may be stored in and queried from one or more database tables 360-372 of the validated product recommendation system.

In one implementation, when a data type (e.g., check in data) is selected, additional results such as the demographics graph 908 may be displayed depicting the geographic location of the users checking in to the interactive toolbar. The admin dashboard 900 may depict check in number as a function of page category. The admin dashboard 900 may depict analytics relating to users, activities, behavior, and the like. Example analytics displayed include, for example, top influencers 910, the associated metrics (e.g., number of users influenced), top statuses 912, products getting more traction, trends, the sentiments (% positive, % negative) 916, sentiment with respect to specific products, brands, etc., sentiments before and after an action is taken, analysis by geographic region (e.g., by state, zip code, country, county, city, etc.), gender, age, and the like. In one implementation, the admin dashboard 900 may also include an area 918 where a list of current users is displayed. In one implementation, the admin may select a user and send a message, offer, promotion, etc., to the user directly from the dashboard user interface. In one implementation, any of the items described with respect to FIGS. 2-3B may be tracked, analyzed, manipulated and/or displayed on the admin dashboard. The admin dashboard 900 may also include tools for printing, emailing, sharing and/or archiving one or more of the reports, statistics, graphs and charts, etc.

### Example Computer Systemization

Aspects and implementations of the validated product recommendation system have been described in the general context of computer-executable instructions, such as routines executed by a general-purpose computer, a personal computer, a server, and/or other computing systems such as the validated product recommendation server 118 illustrated in FIG. 10. In one implementation, the web server 114 and the social networking systems 122 may also be represented by a computer systemization similar to that illustrated in FIG. 10.

The validated product recommendation server 118 may be in communication with entities including one or more users (e.g., users 1052), client devices 1048, user input devices 1002, peripheral devices 1004, an optional co-processor device(s) (e.g., cryptographic processor devices) 1006, and networks 1050. Users may engage with the validated product recommendation server 118 via client devices 1048 over networks 1050.

Computers employ central processing unit (CPU) or processor (hereinafter “processor”) to process information. Processors may include programmable general-purpose or special-purpose microprocessors, programmable controllers, application-specific integrated circuits (ASICs), programmable logic devices (PLDs), embedded components, combination of such devices and the like. Processors execute program components in response to user and/or system-generated requests. One or more of these components may be implemented in software, hardware or both hardware and software. Processors pass instructions (e.g., operational and data instructions) to enable various operations.

The validated product recommendation may include clock 1020, CPU 1022, memory such as read only memory (ROM) 1028 and random access memory (RAM) 1026 and co-processor 1024 among others. These controller components may be connected to a system bus 1018, and through the system bus 1018 to an interface bus 1008. Further, user input devices 1002, peripheral devices 1004, co-processor devices 1006, and the like, may be connected through the interface bus 1008 to the system bus 1018. The Interface bus 1008 may be connected to a number of interface adapters such as processor interface 1010, input output interfaces (I/O) 1012, network interfaces 1014, storage interfaces 1016, and the like.

Processor interface 1010 may facilitate communication between co-processor devices 1006 and co-processor 1024. In one implementation, processor interface 1010 may expedite encryption and decryption of requests or data. Input Output interfaces (I/O) 1012 facilitate communication between user input devices 1002, peripheral devices 1004, co-processor devices 1006, and/or the like and components of the validated product recommendation server 118 using protocols such as those for handling audio, data, video interface, wireless transceivers, or the like (e.g., Bluetooth, IEEE 1394a-b, serial, universal serial bus (USB), Digital Visual Interface (DVI), 802.11a/b/g/n/x, cellular, etc.). Network interfaces 1014 may be in communication with the network. Through the network, the validated product recommendation may be accessible to remote client devices 1048. Network interfaces 1014 may use various wired and wireless connection protocols such as, direct connect, Ethernet, wireless connection such as IEEE 802.11a-x, and the like. Examples of network 1050 include the Internet, Local Area Network (LAN), Metropolitan Area Network (MAN), a Wide Area Network (WAN), wireless network (e.g., using Wireless Application Protocol WAP), a secured custom connection, and the like. The network interfaces 1014 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand. Other network security functions performed or included in the functions of the firewall, can be, for example, but are not limited to, intrusion-prevention, intrusion detection, next-generation firewall, personal firewall, etc., without deviating from the novel art of this disclosure.

Storage interfaces 1016 may be in communication with a number of storage devices such as, storage devices 1032, removable disc devices, and the like. The storage interfaces 1016 may use various connection protocols such as Serial Advanced Technology Attachment (SATA), IEEE 1394, Ethernet, Universal Serial Bus (USB), and the like.

User input devices 1002 and peripheral devices 1004 may be connected to I/O interface 1012 and potentially other interfaces, buses and/or components. User input devices 1002 may include card readers, finger print readers, joysticks, keyboards, microphones, mouse, remote controls, retina readers, touch screens, sensors, and/or the like. Peripheral devices 1004 may include antenna, audio devices (e.g., microphone, speakers, etc.), cameras, external processors, communication devices, radio frequency identifiers (RFIDs), scanners, printers, storage devices, transceivers, and/or the like. Co-processor devices 1006 may be connected to the validated product recommendation server 118 through interface bus 1008, and may include microcontrollers, processors, interfaces or other devices.

Computer executable instructions and data may be stored in memory (e.g., registers, cache memory, random access memory, flash, etc.) which is accessible by processors. These stored instruction codes (e.g., programs) may engage the processor components, motherboard and/or other system components to perform desired operations. The validated product recommendation server 118 may employ various forms of memory including on-chip CPU memory (e.g., registers), RAM 1026, ROM 1028, and storage devices 1032. Storage devices 1032 may employ any number of tangible, non-transitory storage devices or systems such as fixed or removable magnetic disk drive, an optical drive, solid state memory devices and other processor-readable storage media. Computer-executable instructions stored in the memory may include the validated product recommendation system 300 having one or more program modules such as routines, programs, objects, components, managers, data structures, and so on that perform particular tasks or implement particular abstract data types. For example, the memory may contain operating system (OS) component 1034, program modules and other components (e.g., 304-346), database tables 360-372, and the like. These modules/components may be stored and accessed from the storage devices, including from external storage devices accessible through an interface bus.

The database components 360-372 are stored programs executed by the processor to process the stored data. The database components may be implemented in the form of a database that is relational, scalable and secure. Examples of such database include DB2, MySQL, Oracle, Sybase, and the like. Alternatively, the database may be implemented using various standard data-structures, such as an array, hash, list, struct, structured text file (e.g., XML), table, and/or the like. Such data-structures may be stored in memory and/or in structured files.

The validated product recommendation server 118 may be implemented in distributed computing environments, where tasks or modules are performed by remote processing devices, which are linked through a communications network, such as a Local Area Network (“LAN”), Wide Area Network (“WAN”), the Internet, and the like. In a distributed computing environment, program modules or subroutines may be located in both local and remote memory storage devices. Distributed computing may be employed to load balance and/or aggregate resources for processing. Alternatively, aspects of the validated product recommendation server 118 may be distributed electronically over the Internet or over other networks (including wireless networks). Those skilled in the relevant art will recognize that portions of the validated product recommendation system may reside on a server computer, while corresponding portions reside on a client computer. Data structures and transmission of data particular to aspects of the validated product recommendation server 118 are also encompassed within the scope of the invention.

### CONCLUSION

The above Detailed Description of embodiments of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative combinations or subcombinations. Each of these processes or blocks may be implemented in a variety of different ways. Also, while processes or blocks are at times shown as being performed in series, these processes or blocks may instead be performed or implemented in parallel, or may be performed at different times.

In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

We claim:

1. A processor-implemented method of identifying matching users for interaction on a website, comprising:
obtaining a list of users of an interactive component of a website;
selecting, by a processor, online users from the list of users who are signed in to the interactive component of the website;
sorting the online users by one or more criteria to identify matching users for interaction with a user; and
displaying user profiles of the matching users on the interactive component of the website for interaction with the user.

2. The method of claim 1, wherein the one or more criteria includes relationship between the online users and the user.

3. The method of claim 2, wherein the one or more criteria includes sum of common uniform resource locator (URL) page views.

4. The method of claim 3, wherein the online users are sorted by the relationship between the online users and the user, and then by the sum of common URL page views.

5. The method of claim 1, wherein the user logs in to the interactive component of the website using login credentials associated with a social networking system.

6. The method of claim 5, wherein the list of users of the interactive component of the website is obtained from the social networking system.

7. The method of claim 1, further comprising:
allowing exchange of messages between the user and one or more of the matching users via the interactive component of the website.

8. The method of claim 1, further comprising:
receiving a message for a matching user;
detecting that the matching user is offline;
storing the message in a data store; and
delivering the message to the matching user when the user is online.

9. The method of claim 1, further comprising monitoring messages being exchanged between the user and one or more of the matching users via the interactive component of the website.

10. The method of claim 9, further comprising detecting positive or negative sentiment towards a product, a service or a brand on the website from the monitoring of messages.

11. The method of claim 10, wherein in response to the detected negative sentiment, triggering a customer service representative to initiate communication with parties associated with the negative sentiment via the interactive component of the website.

12. The method of claim 1, further comprising:
tracking URL page views of the website by each online user, including the user and the matching users; and
storing the URL page views in association with a user profile corresponding to the online user in a data store.

13. The method of claim 1, further comprising:
tracking products or services viewed, favorited or purchased by the matching users; and
displaying the products or services corresponding to each matching user in association with a user profile of the matching user on the interactive component of the website.

14. The method of claim 1, further comprising:
broadcasting a message concerning an event to the online users via the interactive component of the website.

15. The method of claim 14, wherein the event includes at least one of a sale, an offer, an availability of an expert or an availability of a customer service representative.

16. The method of claim 15, wherein the broadcasting is triggered when a condition specified by a rule is met.

17. The method of claim 15, wherein the broadcasting is initiated by an administrator or operator of the website.

18. A system for identifying users for interaction on a website, comprising:
a processor;
a memory having stored thereon instructions which when executed by the processor causes the processor to:
obtain a list of users of an interactive component of a website;
select from the list of users, online users that have signed on to the interactive component of the website;
order the online users based at least two conditions, wherein one condition specifies that the online users have a friend relationship with a user and the other condition specifies that the online users be arranged based the sum of URL page views that are common between each online user and the user; and
display the selected user profiles on the interactive component of the website.

19. A processor-readable non-transitory medium storing instructions to:
obtain a list of users of an interactive component of a website from a social networking system;
select, from the list of users, online users who are signed in to the interactive component of the website, based on successful authentication of the online users by the social networking system;
order the online users by one or more criteria to identify matching users for interaction with a user; and
display user profiles of the matching users on the interactive component of the website for interaction with the user.

20. A processor-implemented method of exchanging messages via an interactive component of a website:
receiving, a message from a sender via an interactive component of a website, wherein the interactive component of the website has access to user profiles of the sender and a recipient of the message;
storing the message in a data store;
determining that the recipient of the message is not checked in to the interactive component of the website; and
delivering the message to the recipient when the recipient checks in to the interactive component of the website.
